(19) United States
(12) Patent Application Publication
(10) Pub. No.: US 2008/0122832 A1
(43) Pub. Date: May 29, 2008

(54) Image display apparatus

(75) Inventors: Shou Lung Chen, Hong Kong (CN); Chen-Jung Tsai, Hong Kong (CN)

Correspondence Address: TROUTMAN SANDERS LLP, 600 PEACHTREE STREET , NE, ATLANTA, GA, 30308, US

(73) Assignee: Hong Kong Applied Science and Technology Research Institute Company Limited, Hong Kong (CN)

(21) Appl. No.: 11/605,526

(22) Filed: Nov. 29, 2006

(51) Int. Cl. G09G 5/00; G09G 5/10

(52) U.S. Cl. 345/214; 345/55; 345/82; 345/87

(57) ABSTRACT

Methods and apparatuses for image display are disclosed. There is provided an image display apparatus. The apparatus includes a plurality of display modules including display elements manufactured from different bins; a plurality of driving circuits providing different driving conditions for the display modules, at least one driving circuit for each display module; and a control circuit controlling the driving circuits to compensate each display module for variation of characteristics amongst modules of bins. The driving control circuit may include a look up table storing information about one or more characteristics of each display module.

### BACKGROUND OF THE INVENTION

1. Field of the Invention

The present invention relates generally to display arrays and more particularly to controlling the driving of a large panel of display arrays.

2. Description of Related Art

Light emitting diodes (LEDs) have been widely used in lighting systems due to their high efficiency, fast response time and long life span. LEDs also give off less heat than conventional incandescent light bulbs. Importantly, LEDs emit incoherent narrow-spectrum light from the electroluminescence effect. By controlling the doping of semiconductor materials at a p-n junction, the energy band gap can be fine-tuned and hence the wavelength or color of the light emitted by the LED can be controlled.

Characteristics of LEDs include the wavelength of emitted light, luminance, temperature response, current-voltage characteristics (I-V characteristics). Due to process variation, such characteristics of the LEDs usually differ between production bins. Even for the same production bin, variations in LED characteristics still exist and follow a normal distribution. For quality control, only LEDs satisfying the production specification are adopted, while others falling outside the selection window for quality control are discarded. If higher quality is required, the selection window is narrower and the yield becomes lower. This results in higher manufacturing costs.

For LEDs to be used for large panel display, such as the backlight for LCD panel, performance criteria such as brightness and color of the LEDs within the same panel must be uniform. For the reasons described above, it is difficult to obtain a large amount of LEDs with consistent characteristics. Hence, the size of an LED panel is limited by the size of the production bin. The cost for manufacturing large size LED panels is consequently expensive.

Currently, some manufacturers try to increase the yield by relaxing the production specifications, in other words, to trade off cost with quality. However, this does not fundamentally solve the technical problem, and the cost remains high for good quality LED panels.

Another alternative to lower the manufacturing cost is by keeping a stock of disqualified LEDs, and categorizing those LEDs into groups according to their characteristics such as wavelength. These categorized LEDs are reused in future production when a sufficient number are accumulated. However, such a method still does not fundamentally solve the technical problem. Furthermore, the method has disadvantages: i) even if the characteristics remain uniform within a single panel, the characteristics can vary from panel to panel; ii) extra cost in incurred keeping stock of the disqualified LEDs for reuse; iii) the quantity for these reused LEDs produced by the manufacturing process is unpredictable; and, iv) the variation always happens to more than one characteristic, and there are lots of combinations from the wavelength, brightness, biasing voltage, etc. making it difficult to collect disqualified LEDs with the same exact characteristics from different production bins.

Circumstances arise under which part of the LEDs in an operating display panel may burn out after prolong use and need to be replaced. According to conventional technology, it is difficult to produce LEDs of consistent characteristics with the defective LED. Hence the repair cost tends to be high.

Accordingly, a need exists for improved methods and apparatuses to enhance the manufacturing yield, assembly yield and repairability of LED panels.

### BRIEF SUMMARY OF THE INVENTION

According to an aspect of the present invention, there is provided an image display apparatus. The apparatus comprises: a plurality of display modules including display elements manufactured from different bins; a plurality of driving circuits providing different driving conditions for the display modules, at least one driving circuit for each display module; a control circuit controlling said driving circuits to compensate each display module for variation of characteristics amongst display modules manufactured from different bins.

The driving control circuit may comprise a look up table storing information about one or more characteristics of each display module.

The apparatus may further comprise a circuit for dynamically controlling the display modules dependent on the operating conditions of the display modules.

The operating conditions are wavelength of emitted light, intensity of emitted light, working temperature, or operation time. The display element may be a light emitting diode. The characteristics of display elements are based on wavelength of emitted light, intensity of emitted light, or biasing current-voltage relationship. A driving condition provided by each driving circuit may be biasing current or biasing voltage.

The image display apparatus may be used in applications of LCD backlight or LED display panel. The image display apparatus provides uniform, white-balance back lighting or a special pattern composed of different colors.

In accordance with a further aspect of the invention, there is provided a process for manufacturing an image display apparatus. The process comprises the steps of:
characterizing and inspecting manufactured display elements from different bins;
assembling display modules, each having display elements from a single bin, to form a large display array, at least two modules comprising display elements from different bins;
determining the driving conditions for each bin based on the characteristics obtained from characterizing and inspecting said display elements to achieve a desired performance; and
providing compensated driving circuit for each display module with said respective determined driving condition determined to produce light of substantially uniform wavelength or intensity from said large display array.

The process may further comprise the step of manufacturing a plurality of bins of display elements.

The process may further comprise the step of creating display modules using display elements selected from a single bin for each display module.

The display element may be a light emitting diode. The characteristics of display element are based on wavelength of emitted light, intensity of emitted light, or biasing current-voltage relationship. A driving condition provided by each driving circuit may be biasing current or biasing voltage.

In accordance with a further aspect of the invention, there is provided a method of displaying an image. The method comprises the steps of: providing a plurality of display modules consisting of display elements manufactured from different bins; providing different driving conditions for the display modules, at least one driving condition being provided for each display module; and controlling the driving conditions to compensate each display module for variation of characteristics amongst modules of bins.

The controlling step may comprise storing information about one or more characteristics of each display module in a look up table.

The display modules may be controlled dynamically dependent on the operating conditions of said display modules.

The operating conditions are wavelength of emitted light, intensity of emitted light, working temperature, or operation time. The display element may be a light emitting diode. The characteristics of display element are based on wavelength of emitted light, intensity of emitted light, or biasing current-voltage relationship. A driving condition provided by each driving circuit may be biasing current or biasing voltage.

The method may be used for providing LCD backlighting or displaying an image in a LED display panel. The method provides a uniform, white-balance back lighting or a special pattern composed of different colors.

### BRIEF DESCRIPTION OF THE FIGURES

One or more embodiments are described hereinafter, by way of examples only, with reference to the accompanying drawings in which:

FIG. 1a is a schematic block diagram representing an LED driving system architecture with static compensated control in accordance with an embodiment of the present invention;

FIGS. 1b-1e are plots showing the characteristics of LED bins before and after compensation control according to embodiments of the present invention;

FIG. 1f is a typical implementation of the driving circuits in FIG. 1a;

FIG. 2a is a plot showing the relationship of LED wavelength shift against forward biasing current and control mechanism for wavelength shift compensation;

FIG. 2b is a plot showing the relationship of LED intensity against forward biasing current and control mechanism for intensity compensation;

FIG. 2c is a plot showing the relationship of LED forward biasing current against forward biasing voltage;

FIG. 3 is a flow diagram illustrating a manufacturing process for the LED driving system with compensated control in accordance with an embodiment of the present invention;

FIG. 4 is a schematic block diagram representing a LED driving system architecture with dynamic compensated control in accordance with an embodiment of the present invention;

FIG. 5 is a plot showing the relationship of LED wavelength shift against the junction temperature and control mechanism for temperature compensation;

FIG. 6 is a flow diagram illustrating the process of dynamic compensation in accordance with an embodiment of the present invention; and

FIG. 7 is a flow diagram illustrating the method of displaying an image in accordance with an embodiment of the present invention.

### DETAILED DESCRIPTION OF PREFERRED EMBODIMENTS

Where reference is made in any one or more of the accompanying drawings to steps and/or features, which have the same reference numerals, those steps and/or features have for the purposes of this description the same function(s) or operations(s), unless the contrary intention appears.

A LED array system comprising LED modules manufactured from at least two different production bins is described hereinafter. LEDs are assembled into LED modules which are driven by separate driving circuits. All LEDs in a single LED module are manufactured from the same production bin, the characteristics within each module such as wavelength, brightness are consistent. While different LED modules may have LEDs from different production bins, the characteristics may vary between different LED modules. To provide a uniform performance across the whole LED array, each module is biased under different driving conditions to compensate the difference. Such driving conditions are determined by the individual characteristics of each bin, which are measured during the manufacturing process. In one embodiment, the compensation control is provided in a static manner and is preset in the manufacturing process. In another embodiment, the compensation control is dynamic and determined also by the operating conditions of the LED array system.

The methods in accordance with the embodiments described herein have general applicability to LED display array systems. For ease of explanation, the embodiments of the invention are described with reference to LED backlight array systems in white balance for LCD backlight. However, it is not intended that the present invention be limited to the described embodiments. For example, the methods may have application to multicolor LED display panel, wherein each LED device represents a pixel of the image and operates independently. Nevertheless, the whole panel desirably provides a uniform performance, especially when the neighboring pixels are required to display the same color and intensity. To apply the method to such LED panel, the whole panel is similarly partitioned into smaller modules. A default offset biasing is applied to each module to compensate for the variation of characteristics between modules. The compensated control may also vary for different colors of LEDs (e.g., Red, Green, Blue).

According to the process of manufacturing LED array system in the present invention, the required quantity of LEDs with consistent characteristics can be substantially reduced. Therefore, it is easier to manufacture large LED panels of high quality. In other words, the manufacturing yield and assembly yield is also enhanced and subsequently lead to a reduction in manufacturing cost.

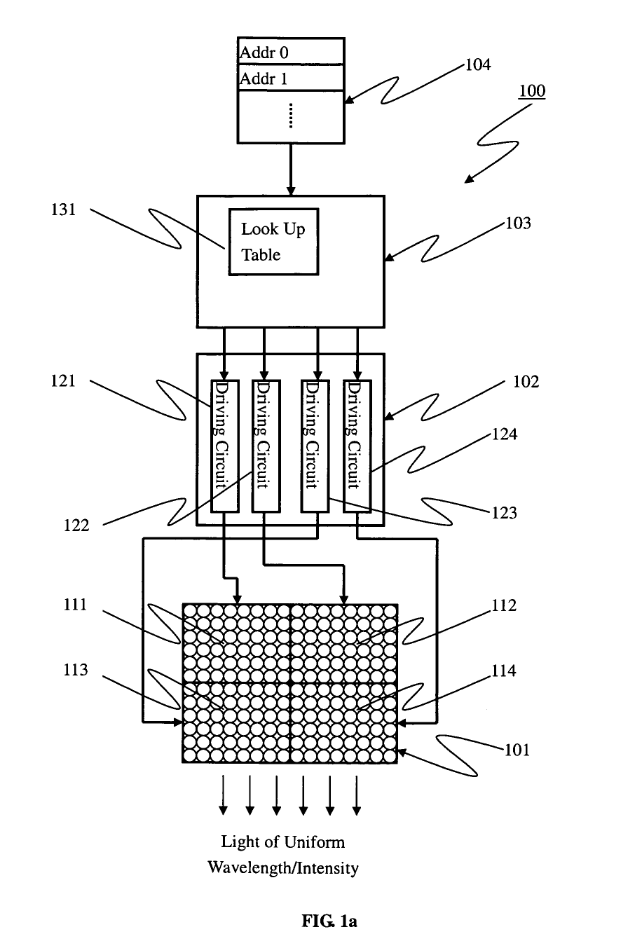

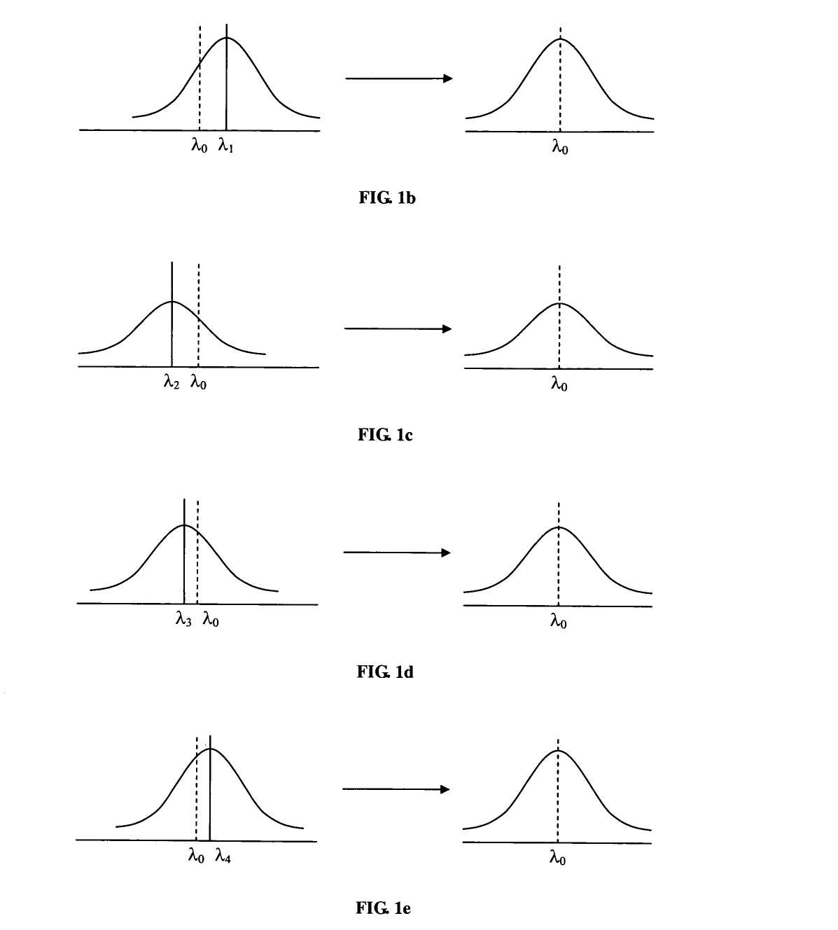

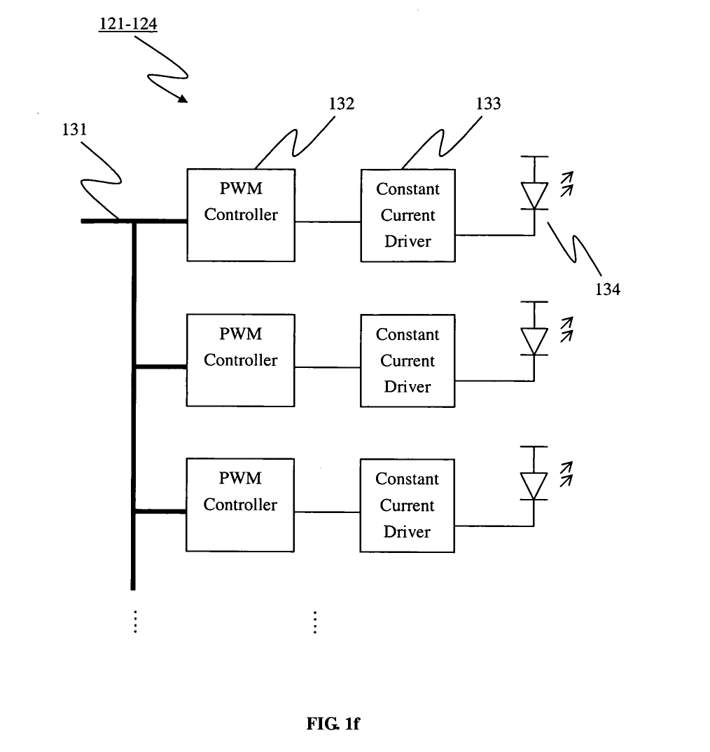

FIG. 1a is a block diagram of a LED array system 100 in accordance with an embodiment of the invention. A large LED array 101 is partitioned spatially into LED modules 111, 112, 113, 114 of smaller size. For example, a large LED array of 240 red LEDs, 240 green LEDs and 120 blue LEDs can be divided into 12 modules. Each module uses LEDs from a different production bin, for example, module 111 has LEDs from bin 1, module 112 from bin 2, module 113 from bin 3 and module 114 from bin 4.

Despite the different characteristics of different modules 111-114, such as wavelength, luminosity, each module has substantially uniform characteristics among its LEDs because the LEDs come from the same bin. The performance of all modules 111-114 can be united by separate LED driving circuits through providing driving conditions to compensate for the variations. Compensated control is provided based on the offset of characteristics, such as the wavelength, and the intensity of the relevant LED module.

Each LED module 111-114 is biased under separate driving conditions, for example, biasing voltage or current. Individual LED driving circuits 121, 122, 123, 124, each receiving instructions from the driving control circuit 103, can provide adjustable driving voltages or currents to the LED modules 111, 112, 113, 114, respectively.

In an embodiment of the invention, the driving control circuit 103 contains a storage unit 104 to store the driving parameters for each module 111-114. The driving control circuit may further contain a look up table (LUT) 131 to convert the driving parameters into control signals for driving circuits 121, 122, 123, 124.

Table 1 shows the contents of LUT 131.

TABLE 1

| Address | Contents |
|---|---|
| 0x0000 | driving current duty cycle when biasing voltage = V0 (For bin 1) |
| 0x0001 | driving current duty cycle when biasing voltage = V1 |
| 0x0002 | driving current duty cycle when biasing voltage = V2 |
| 0x0003 | driving current duty cycle when biasing voltage = V3 |
| . . . | . . . |
| 0x0010 | driving current duty cycle when brightness = LUX0 (For bin 1) |
| 0x0011 | driving current duty cycle when brightness = LUX1 |
| 0x0012 | driving current duty cycle when brightness = LUX2 |
| 0x0013 | driving current duty cycle when brightness = LUX3 |
| . . . | . . . |
| 0x0020 | driving current duty cycle when wavelength = Lamda0 |
| | (For bin 1) |
| 0x0021 | driving current duty cycle when wavelength = Lamda1 |
| 0x0022 | driving current duty cycle when wavelength = Lamda2 |
| 0x0023 | driving current duty cycle when wavelength = Lamda3 |
| . . . | . . . |
| 0x0100 | driving current duty cycle when biasing voltage = V0 (For bin 2) |
| . . . | . . . |
| 0x0110 | driving current duty cycle when brightness = LUX0 (For bin 2) |
| . . . | . . . |
| 0x0120 | driving current duty cycle when wavelength = Lamda0 |
| | (For bin 2) |
| . . . | . . . |
| 0x0200 | driving current duty cycle when biasing voltage = V0 (For bin 3) |
| . . . | . . . |
| 0x0210 | driving current duty cycle when brightness = LUX0 (For bin 3) |
| . . . | . . . |
| 0x0220 | driving current duty cycle when wavelength = Lamda0 |
| | (For bin 3) |
| . . . | . . . |

The address bits of LUT 131 represent conditions for a certain driving current duty cycle. In the example, bit 0-3 represent the variation in a certain characteristics (V0, V1, V2 . . . ); bit 4-7 represent the type of characteristics (biasing voltage, brightness, wavelength); bit 8-12 represent the bin number. Accordingly, the content in address 0x0110 is the driving current for bin 1 to provide a brightness of LUX0. If the manufacturer wishes to bias module 112 comprising bin 1 LEDs to emit light of brightness LUX0, the binary value of 0x0110 should be fed into LUT 131 address bus either from storage unit 104 or control circuits like microcontroller. LUT 131 then outputs the desired driving current duty cycle in binary format to the control bus of driving circuit 121.

FIG. if shows a typical implementation of driving circuits 121-124, comprising a series of pulse width modulation (PWM) controllers 132 and constant current drivers 133, while each constant current driver 133 provides biasing current for a single LED 134 in the module. The output of LUT 131 is coupled to PWM controllers 132 through control bus 131. PWM controllers 132 control constant current drivers 133 to provide biasing current with desired duty cycle. A higher duty cycle ratio is equivalent to a larger driving current. Therefore, by varying the duty cycle of a constant biasing current, the brightness of the LED 134 can be adjusted to LUX0.

FIGS. 1b-1e illustrate the compensation for LED characteristics, for example, the compensated wavelength λ₀emitted light of modules 111-114. FIG. 1b shows the original distribution of module 111 with λ₁ as the average or center wavelength. Assuming that the target wavelength of the whole LED array 101, λ₀, is slightly smaller than λ₁, the driving control circuit 103 causes the driving circuit 121 to adjust the driving condition, for example, by increasing the driving current for module 111, such that the average value of the distribution is reduced to λ₀.

FIG. 1c shows the original distribution of module 112 with λ₂ as medium wavelength. Assuming that the target wavelength of the whole LED array 101, λ₀, is slightly larger than λ₂, the driving control circuit 103 causes the driving circuit 122 to adjust the driving condition, for example, by reducing the driving current for module 112, such that the medium of the distribution is increased to λ₀.

FIG. 1d shows the original distribution of module 113 with λ₃ as medium wavelength. Assuming that the target wavelength of the whole LED array 101, λ₀, is slightly larger than λ₃, the driving control circuit 103 causes the driving circuit 123 to adjust the driving condition, for example, by reducing the driving current for module 113, such that the medium of the distribution is increased to λ₀.

FIG. 1e shows the original distribution of module 114 with λ₄ as medium wavelength. Assuming that the target wavelength of the whole LED array 101, λ₀, is slightly smaller than λ₄, the driving control circuit 103 causes the driving circuit 124 to adjust the driving condition, for example, by increasing the driving current for module 114, such that the medium of the distribution is reduced to λ₀. As a result, all the modules 111-114 in LED array 101 emit light of substantial uniform wavelength of λ₀ under compensated driving conditions.

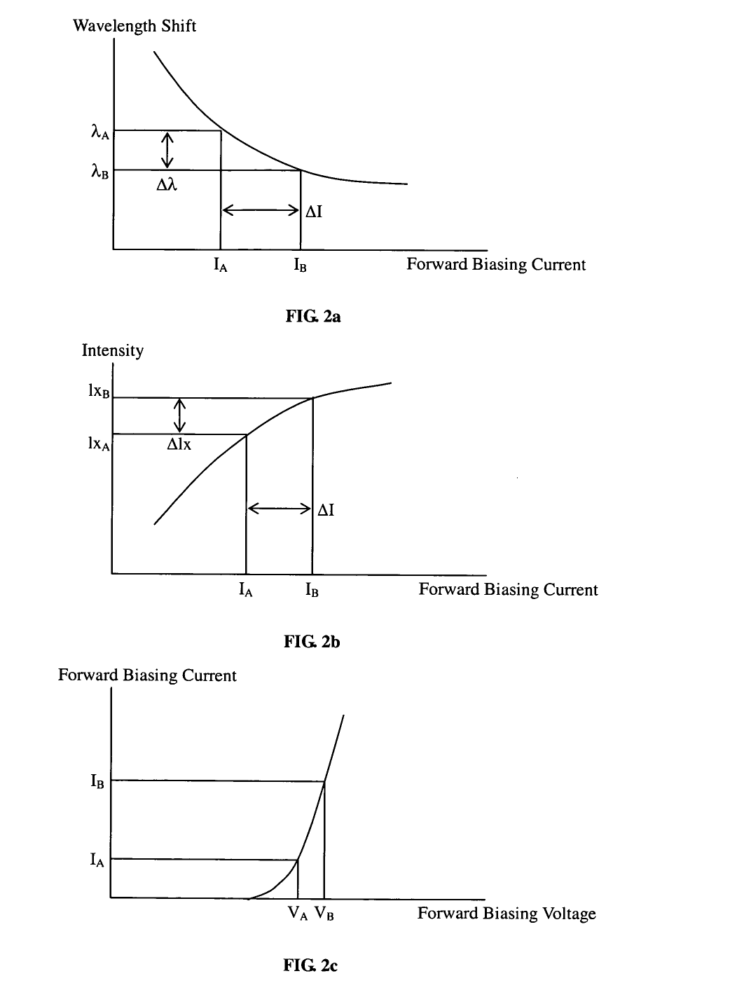

FIG. 2 further illustrates how the performance of each LED module 111-114 can be tuned by varying the driving conditions. FIG. 2a shows the relationship of LED wavelength shift against forward biasing current, which is a control mechanism for wavelength shift compensation. λ_{A} is the wavelength shift of the emitted light under default driving current I_{A}. Assuming that λ_{A} is the desired shift to provide the target wavelength of the whole LED array, the driving circuit increases the driving current by ΔI to I_{B}.

FIG. 2b shows the relationship of LED intensity against forward biasing current which is a control mechanism for intensity compensation. lx_{A} is the intensity of the emitted light under default driving current I_{A}. Assuming that lx_{B} is the desired intensity to provide a uniform intensity of the whole LED array, the driving circuit increases the driving current by ΔI to I_{B} to produce an intensity shift of Δlx.

The above measures to compensate any LED's performance may at the same time affect some other performances. For example, when trying to minimize the wavelength shift, the driving current may have to be reduced. Such current reduction also results in a decrease of luminosity for the LED module 111-114 and hence non-uniform intensity across the LED array 101. Therefore, the priority of the performances must be decided when applying compensation according to the embodiments of the present invention. Generally speaking, uniform wavelength is of higher priority for home theater TV, but the intensity is more important for outdoor display.

Alternatively, the driving conditions can be adjusted through the driving voltage instead of the driving current. FIG. 2c shows the relationship of LED forward biasing current against forward biasing voltage. If a LED module must be biased at a current of I_{B} instead of an original current of I_{A} to provide compensation, the driving circuit 102 can alternatively drive in voltage mode and adjust the driving voltage from V_{A} to V_{B}.

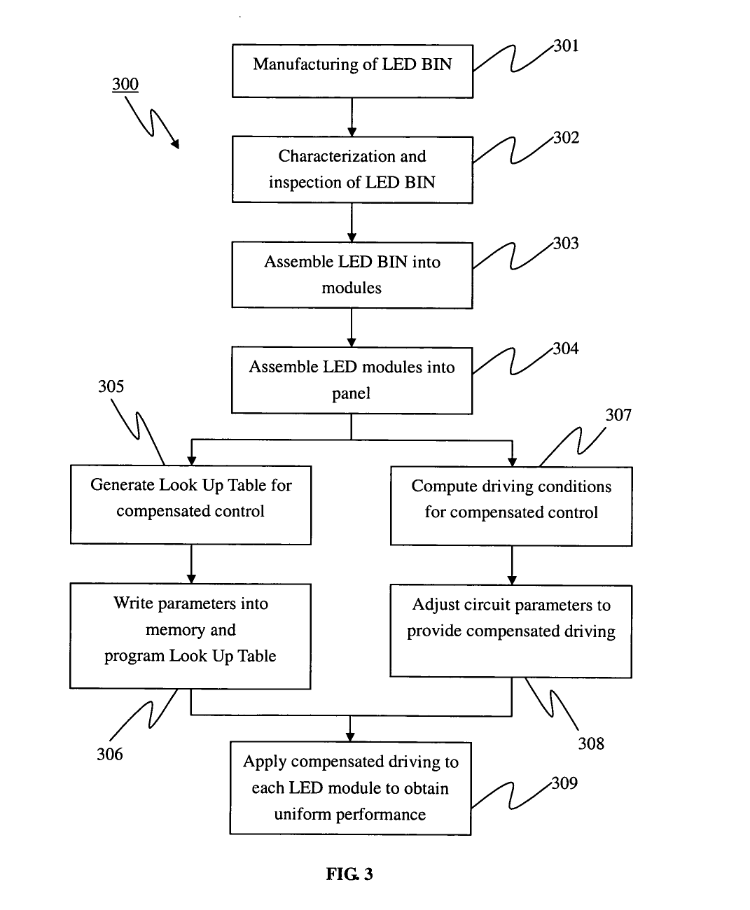

FIG. 3 shows a process 300 of manufacturing a LED driving system with compensated control in accordance with an embodiment of the invention. In step 301, LEDs are manufactured in any convention manners.

In step 302, the LEDs are characterized and inspected from a bin. Relevant parameters for each production bin may be recorded in a database. The parameters include wavelength, intensity, and I-V characteristics for biasing current and voltage. The LEDs are inspected and those that fail to satisfy the production specification under compensated driving are discarded.

In step 303, the LEDs from each production bin are assembled to create LED modules from the respective bin, such that all LEDs in a module are produced from the same bin.

In step 304, the LED modules are assembled to form a panel. Such modules composing the large panel are not required to have the same characteristics. The characteristics may vary between different modules, a lower manufacturing cost is therefore resulted because a smaller quantity of LEDs having substantially uniform characteristics are required by this method.

Steps 305 and 306 on the one hand and steps 307 and 308 on the other, while shown as parallel branches in FIG. 3 are alternate embodiments of the invention, as described hereinafter.

According to one embodiment of the invention (steps 305 and 306), in step 305 the data in LUT 131 of the driving control circuit 103 is generated for compensated control. This may be done using the LED characteristics measured in step 302. In step 306, the parameters are written into memory and the LUT 131 is programmed with the data. The storage unit 104 is written into with parameters, such as the medium wavelength of the relevant bin. The driving control circuit 103 translates and converts such parameters to control signals for the driving circuit 102 to provide adequate driving conditions such that the LEDs achieve a target performance. Each address space of the storage unit 104 stores the parameters for one LED module.

In another embodiment of the invention (steps 307 and 308), in step 307, the driving conditions for each production bin are computed for compensated control. This is done based on the bin parameters obtained in characterization step 302. In step 308, the circuit parameters are adjusted to provide compensated driving conditions as determined in step 307. The parameters may be, for example, resistor values in a feedback network.

Processing continues from either step 306 or 308. In step 309, compensated driving is applied to each LED module to obtain uniform performance. The LED module is coupled to individual driving circuit and receives optimum driving conditions to provide a uniform performance throughout the whole array 101.

The yield can be further enhanced if the disqualified LEDs in each bin can be categorized according to their characteristics and form some other modules. These modules are again driven by compensated control by appropriate driving conditions to provide substantially the same performance as other modules in the LED array 101.

Compensation provided by above methods is static and is usually predetermined during the manufacturing process. In contrast, another embodiment of the invention provides dynamic compensation to adapt changes in LED characteristics during operation.

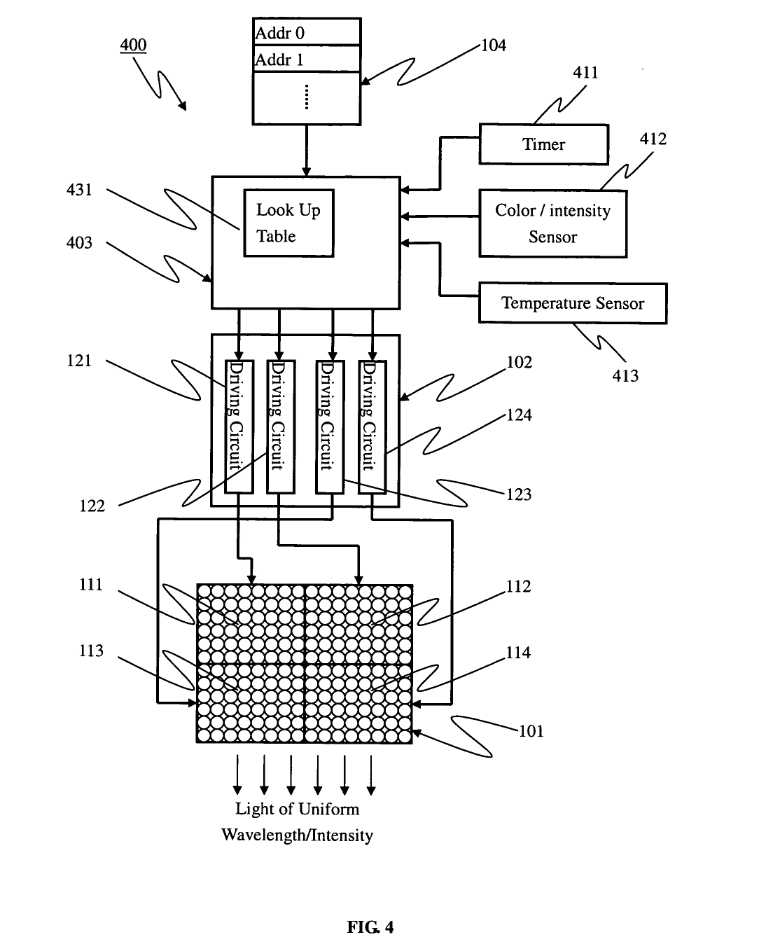

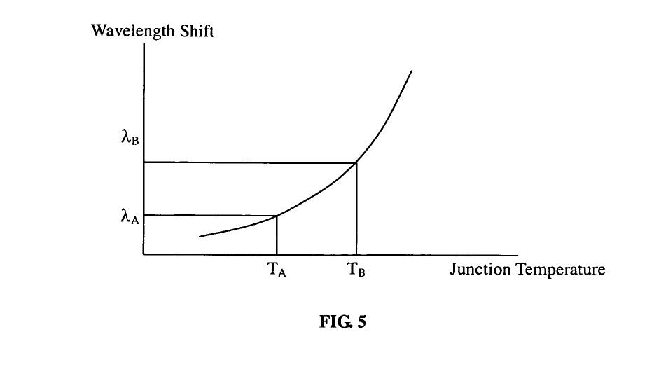

In the embodiment shown in FIG. 4, dynamic compensation can be performed using a timer 411 in the LED panel system 400, which keeps record of the operation time of the LED panel 101. The timer 411 is coupled to the driving control circuit 403 which receives timer information and commands the driving circuits 102 to adjust the driving conditions accordingly. As such, the aging effect of the LED system 400, for example, reduction in intensity, can be compensated (such as, by increasing biasing current) based on the timer value.

In particular, LUT 431 in control circuit 403 contains additional address bits (bit 16-19) compared to LUT 131 of FIG. 1. These additional address bits represent the time that a LED module has operated and are driven by time signal provided by timer 411. The contents in LUT 431 are shown in Table 2 below. Based on different values of the time signal, LUT 431 looks up the corresponding address and outputs data representing the desired driving condition stored therein, which is the value of driving current duty cycle in this example. The LUT output is in binary format and directly controls the LED driving circuits 121-124 to provide desired driving condition.

TABLE 2

| Address | Contents |
|---|---|
| . . . | . . . |
| 0x00010 | driving current duty cycle when brightness = LUX0 |
| | (For bin 0, 0–5000 operating hrs) |
| 0x00011 | driving current duty cycle when brightness = LUX1 |
| 0x00012 | driving current duty cycle when brightness = LUX2 |
| 0x00013 | driving current duty cycle when brightness = LUX3 |
| . . . | . . . |
| 0x10010 | driving current duty cycle when brightness = LUX0 |
| | (For bin 0, 5000–10000 operating hrs) |
| 0x10011 | driving current duty cycle when brightness = LUX1 |
| 0x10012 | driving current duty cycle when brightness = LUX2 |
| 0x10013 | driving current duty cycle when brightness = LUX3 |
| . . . | . . . |
| 0x20010 | driving current duty cycle when brightness = LUX0 |
| | (For bin 0, 10000–15000 operating hrs) |
| 0x20011 | driving current duty cycle when brightness = LUX1 |
| 0x20012 | driving current duty cycle when brightness = LUX2 |
| 0x20013 | driving current duty cycle when brightness = LUX3 |
| . . . | . . . |

In another embodiment, dynamic compensation can be implemented using performance sensors 412, such as color sensor or light intensity sensor, in each LED module 111-114. Performance of the LED modules 111-114 is monitored continuously or at time intervals in respect of conditions such as wavelength or intensity of the emitted light. In case any variation of performance is detected, the sensors 412 will feedback such information to the driving control circuit 403 (through a comparator or ADC). The driving control circuit 403 refers to the LUT 431 and commands the driving circuit 102 to adjust the driving conditions and compensate the offset in performance.

Similar to Table 2 in time compensation case, LUT 431 can be extended to include driving conditions under various measured performance. The additional address bits may represent the performance deviation. For example, when the intensity of a certain module, say 111, drops by 10 Lux, sensor 412 such as a phototransistor detects the change and feedbacks a signal to LUT 431. If it is analog signal, an Analog to Digital Converter (ADC) is required to convert it to digital signal. This digital sensor signal is fed to the address input of LUT 431 to fetch the driving condition which can provide an additional 10 Lux. LUT 431 outputs the corresponding content in binary format and commands the LED driver, say 111, to provide driving for compensating the 10 Lux drop.

In another embodiment, dynamic compensation can be implemented by incorporating temperature sensors 413 to the LED array system 400. A common disadvantage of LEDs is that the wavelength may shift substantially due to the change in the working temperature of the operating environment. According to this embodiment of the invention, the driving control circuit 403 uses the feedback signal from the temperature sensor 413 and estimates the temperature effect on each LED module 111-114. The estimation is based on the relevant parameters measured during the manufacturing process and stored in the LUT 431 to provide driving conditions on each LED module to achieve uniform and desirable performance throughout the whole LED array 101 even under temperature change. The contents of LUT 431 in this embodiment are similar to Table 2, except the additional address bits now represent variation of temperature.

FIG. 5 shows the relationship of LED wavelength shift against the junction temperature and control mechanism for temperature compensation. λ_{A} is the wavelength shift of the emitted light under junction temperature T_{A}. Assuming that the junction temperature rises to T_{B}, the wavelength shift therefore becomes λ_{B}. To recover the wavelength shift to λ_{A} and provide the target wavelength of the whole LED array, the driving conditions should be adjusted according to the mechanism depicted in FIGS. 2a-2c.

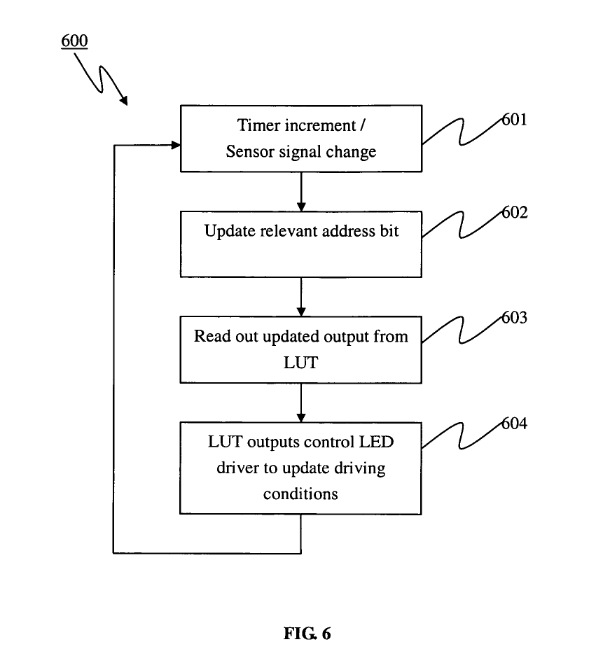

FIG. 6 shows the flow diagram to summarize the dynamic compensation. In step 601, either the timer is incremented or a change in operating conditions of a LED module is detected by sensors, such as color sensor, intensity sensor and temperature sensor. In step 602, the address bits relevant to the time or change in conditions are updated. In step 603, an updated binary output is read out from the LUT based on the change of address bits, such binary output represents the desired driving condition to compensate the change in operating conditions. In step 604, the LUT output is fed to the control bus of the LED driving circuits which is instructed to update driving conditions for the relevant LED module. After compensated driving is provided, the system flow goes back to step 601 and waits for another timer increment or change in operating conditions.

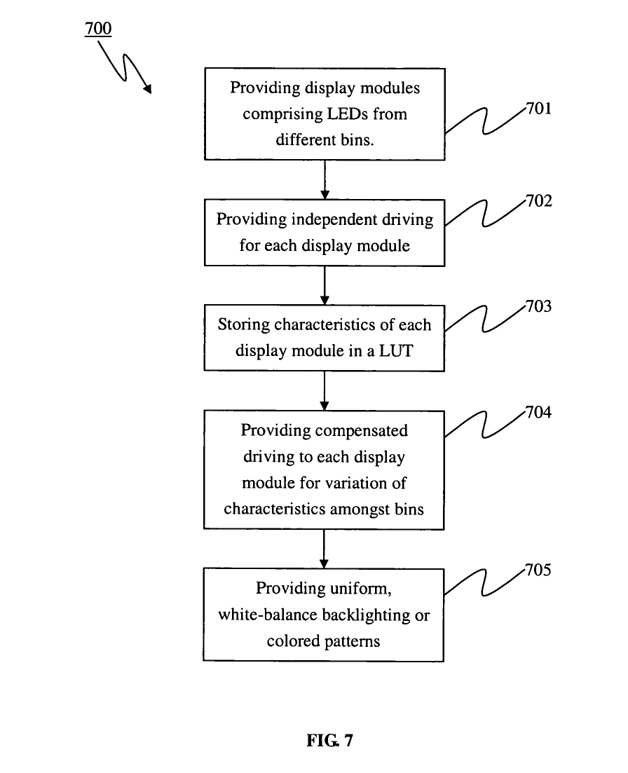

FIG. 7 shows the flow diagram of displaying an image according to an embodiment of the present invention. In step 701, display modules are provided by assembling LEDs manufactured from different bins.

In step 702, independent driving condition is provided for each display module.

In step 703, information about one or more characteristics of each display module is stored in a look up table. The module characteristics can be wavelength of emitted light, intensity of emitted light, and biasing current-voltage relationship.

In step 704, the driving conditions are controlled to compensate each display module for variation of characteristics amongst modules of bins. The driving conditions may be biasing current or biasing voltage. Each display module are controlled dynamically dependent on the operating conditions of the display modules, such as wavelength of emitted light, intensity of emitted light, working temperature, and operation time.

In step 705, uniform, white-balance backlighting is provided in a LCD display or a special pattern composed of different colors is provided in a LED display panel.

### INDUSTRIAL APPLICABILITY

The embodiments and arrangements described hereinafter are applicable to electronics, lighting and display industries, amongst others.

The foregoing describes only a few embodiments of the present invention, and modifications and/or substitutions can be made thereto without departing from the scope and spirit of the invention, the embodiments being illustrative and not restrictive.

The claims defining the invention are as follows:

1. An image display apparatus comprising:
a plurality of display modules consisting of display elements manufactured from different bins;
a plurality of driving circuits providing different driving conditions for said display modules, at least one driving circuit for each display module; and
a control circuit controlling said driving circuits to compensate each display module for variation of characteristics amongst display modules manufactured from different bins.

2. An image display apparatus of claim 1, wherein said control circuit comprises a look up table storing information about one or more characteristics of each display module.

3. An image display apparatus of claim 1, further comprising a circuit for dynamically controlling said display modules dependent on the operating conditions of said display modules.

4. An image display apparatus of claim 3, wherein said operating conditions are selected from the group of conditions consisting of wavelength of emitted light, intensity of emitted light, working temperature, and operation time.

5. An image display apparatus of claim 1, wherein each display element is a light emitting diode.

6. An image display apparatus of claim 1, wherein one or more characteristics of said display elements is selected from the group of characteristics consisting of wavelength of emitted light, intensity of emitted light, and biasing current-voltage relationship.

7. An image display apparatus of claim 1, wherein a driving condition provided by each driving circuit is selected from the group of driving conditions consisting of biasing current and biasing voltage.

8. An image display apparatus of claim 1 is either a display apparatus for LCD backlight or LED display panel.

9. An image display apparatus of claim 8 wherein said apparatus provides uniform, white-balance back lighting or a special pattern composed of different colors.

10. A process for manufacturing an image display apparatus comprising steps of:
characterizing and inspecting manufactured display elements from different bins;
assembling display modules, each having display elements from a single bin, to form a large display array, at least two modules comprising display elements from different bins;
determining the driving conditions for each bin based on the characteristics obtained from characterizing and inspecting said display elements to achieve a desired performance; and
providing compensated driving circuit for each display module with said respective determined driving condition determined to produce light of substantially uniform wavelength or intensity from said large display array.

11. The process according to claim 10, further comprising step of manufacturing a plurality of bins of display elements.

12. The process according to claim 10, further comprising step of creating display modules using display elements selected from a single bin for each display module.

13. The process according to claim 10, wherein each display element is a light emitting diode.

14. The process according to claim 10, wherein one or more characteristics of said display element is selected from the group of characteristics consisting of wavelength of emitted light, intensity of emitted light, and biasing current-voltage relationship.

15. The process according to claim 10, wherein a driving condition provided by each driving circuit is selected from the group of driving conditions consisting of biasing current and biasing voltage.

16. A method of displaying an image, said method comprising the steps of:
providing a plurality of display modules comprising display elements manufactured from different bins;
providing different driving conditions for said display modules, at least one driving condition being provided for each display module; and
controlling said driving conditions to compensate each display module for variation of characteristics amongst modules of bins.

17. The method according to claim 16, wherein controlling step comprises storing information about one or more characteristics of each display module in a look up table.

18. The method according to claim 16, wherein said display modules are controlled dynamically dependent on the operating conditions of said display modules.

19. The method according to claim 18, wherein said operating conditions are selected from the group of conditions consisting of wavelength of emitted light, intensity of emitted light, working temperature, and operation time.

20. The method according to claim 16, wherein each display element is a light emitting diode.

21. The method according to claim 16, wherein one or more characteristics of said display element is selected from the group of characteristics consisting of wavelength of emitted light, intensity of emitted light, and biasing current-voltage relationship.

22. The method according to claim 16, wherein a provided driving condition is selected from the group of driving conditions consisting of biasing current and biasing voltage.

23. The method according to claim 16, wherein said method provides LCD backlighting or displays an image in a LED display panel.

24. The method according to claim 23, wherein said method provides uniform, white-balance back lighting or a special pattern composed of different colors.
